(19) United States
(12) Patent Application Publication
(10) Pub. No.: US 2018/0336913 A1
(43) Pub. Date: Nov. 22, 2018

(54) METHOD TO IMPROVE TEMPORARILY IMPAIRED SPEECH RECOGNITION IN A VEHICLE

(71) Applicant: FORD GLOBAL TECHNOLOGIES, LLC, Dearborn, MI (US)

(72) Inventors: Christoph ARNDT, Moerlen Rheinland-Pfalz (DE); Frederic STEFAN, Aachen NRW (DE); Uwe GUSSEN, Huertgenwald NRW (DE); Anke DIECKMANN, Bad Marienberg / Eichenstruth (DE)

(73) Assignee: FORD GLOBAL TECHNOLOGIES, LLC, Dearborn, MI (US)

(21) Appl. No.: 15/977,494

(22) Filed: May 11, 2018

(30) Foreign Application Priority Data
May 18, 2017 (DE) 102017208382.4

(51) Int. Cl. G10L 21/0364; G10L 21/0216; G10L 15/20; B60W 40/02

(52) U.S. Cl. CPC G10L 21/0364; G10L 21/0216; B60W 2420/52; B60W 40/02; G10L 15/20

(57) ABSTRACT

A method improves temporarily-impaired automatic speech recognition or speech clarity of telecommunication in a vehicle through temporary countermeasures. At least an environment in a direction of travel in front of the vehicle is observed with one or more sensors installed in or on the vehicle. Using observation data obtained, objects in of the environment of the vehicle are determined that represent potential, time-variant noise sources and that the vehicle is expected, on the basis of a detected relative movement between the vehicle and objects, to approach close enough to impair the speech recognition or speech clarity in the vehicle. A start and end of the expected influence of an object determined in this way on the speech recognition or speech clarity are calculated. Countermeasures are taken for a duration of the passing of an object, which is based on the start and end of the expected influence.

### CROSS-REFERENCE TO RELATED APPLICATIONS

This application claims foreign priority benefits under 35 U.S.C. § 119(a)-(d) to DE Application 10 2017 208 382.4 filed May 18, 2017, which is hereby incorporated by reference in its entirety.

### TECHNICAL FIELD

The disclosure relates to a method to improve temporarily impaired speech clarity of telecommunications in a vehicle.

### BACKGROUND

Modern motor vehicles more and more frequently have speech processing systems that enable voice control of vehicle functions. The quality of the speech recognition within the speech processing system is impaired by superimposed external noises, which occur during driving on public roads. In particular, time-variant noises or noise of a changing nature and/or amplitude from the environment of the vehicle substantially impair performance of the voice control.

U.S. Pat. No. 7,725,315 B1 discloses a system to improve the quality of speech signals in which temporary driving noise originating from the road can be identified using characteristic signal properties and can be distinguished from speech signals. Corresponding signal characteristics are, for example, pairs of time-related sound events, if first the front wheels and then the rear wheels pass an unevenness of the road, and other characteristic time profiles of signal strengths and frequencies. For better recognition of temporary driving noise, different temporal and spectral characteristics of temporary driving noise are modelled and compared with the just acquired microphone signal.

One particular challenge for speech recognition is posed by suddenly occurring ambient noises that are not correlated either with other noises or with one another. Time-variant ambient noises are, in particular those that originate from other vehicles in an environment of the vehicle when vehicles approach one another, but, for example, also driving and engine noises of the driver's own vehicle if it passes in close proximity to a sound-reflecting surface such as, for example, a moving or stationary truck, a house wall, a noise barrier or a traffic sign. Time-variant ambient noises of this type typically occur very frequently and in countless variants when driving on public roads.

Voice control systems are normally trained with a specific dataset, and these data may also contain a limited quantity of variations, e.g. variations of the acoustic model for the passenger compartment, etc. The models and variations that a training dataset of a voice control system would have to contain in order to be able to cope with even some of the situations in which the aforementioned time-variant ambient noise occurs would be much too numerous. And, since the voice control system does not know or cannot predict when interfering noises of this type will occur, it cannot respond thereto in a timely manner through countermeasures or modified system settings. Such sudden changes in the ambient noise therefore always impair performance of voice control systems.

Knowledge of the sound level in the voice control system improves the speech recognition and can be included in the system as an additional parameter. This was shown in the publication by X. Feng, B. Richardson, S. Amman, J. Glass: On using heterogeneous data for vehicle-based speech recognition: a DNN-based approach. Proc. Int. Conf. on Acoustics, Voice and Signal Process. (ICASSP) 2015, Brisbane, Australia, pp. 4385-4389, April 2015. It is proposed therein to use the knowledge of the state of systems installed in the vehicle, such as, for example, blower setting or extent of window opening, to improve speech recognition.

### SUMMARY

The object of the disclosure is to be able to estimate more accurately an influence of time-variant noises from an environment of a vehicle on a quality of automatic speech recognition and thus reduce said influence through corresponding adaptation and adjustment of the speech recognition and voice control.

The method according to the disclosure enables a dynamic and time-variant prediction, influence estimation and elimination of time-variant interfering noise sources in a vicinity of a vehicle.

According to the disclosure, at least an environment in a direction of travel in front of the vehicle is observed with one or more sensors installed in or on the vehicle. Using observation data obtained from the sensors, objects in the vicinity of the vehicle are determined that represent potential time-variant noise sources and that the vehicle is expected, on the basis of a detected relative movement between the objects and the vehicle, to approach close enough to impair speech recognition or speech clarity in the vehicle. The start and end of an expected influence of an object determined in this way on the speech recognition or speech clarity are calculated and countermeasures are taken for a duration of passing of an object is determined in this way.

The method according to the disclosure enables a dynamic and time-variant prediction, influence estimation and elimination of time-variant interfering noise sources in a vicinity of the vehicle.

In one preferred embodiment, each of the objects is classified as falling within one of a plurality of classes of objects on the basis of parameters that comprise at least an object speed or object speed relative to the vehicle, and also dimensions of the object, but also parameters such as, for example, object structure, surface area, surface structure, meeting angles, etc.

At least one characteristic noise pattern is preferably stored for each class of objects, wherein the countermeasures are carried out taking account of one of a stored noise pattern, which most closely approximates a currently detected object according to the parameters of said object.

In one preferred embodiment, at least one microphone installed in the vehicle is used during driving operation to continuously record a sound signal in order to pick up noises from passing objects, wherein noise patterns and/or characteristic parameters of these noises, e.g. how quickly the noises swell and fade, are stored and subsequently used as empirical values to improve the speech recognition or speech clarity. If the driver is issuing commands just as the noises occur, an instantaneous degree of influence on speech recognition quality or speech clarity can also be determined and stored.

The sensors preferably are or comprise one or more cameras, lidar, radar and/or ultrasound to acquire two-dimensional or three-dimensional images.

In one preferred embodiment, the objects observed to carry out the method are vehicles in public road traffic. The method is particularly suitable for being carried out in a moving vehicle, but it can also be carried out when the vehicle is stationary.

Insofar as the method, as preferred, is used to improve automatic speech recognition of a voice control system in a vehicle, the countermeasures against temporarily impaired automatic speech recognition preferably consist in switching the speech recognition for a duration of the expected influence of a determined object on the speech recognition, i.e. for the duration of the passing of an object determined as a potential interfering noise source, depending on a nature of the influence to be expected, over to a more robust or more sensitive operating mode that reduces the error rate of the word recognition.

Additionally or alternatively, countermeasures against temporarily impaired automatic speech recognition or speech clarity may consist in temporarily carrying out a noise suppression method to reduce an influence of noise on speech signals for the duration of the expected influence of a determined object on the speech recognition or speech clarity. A description of example embodiments follows with reference to the drawings. The vehicle may be moving, but may also be stationary.

### BRIEF DESCRIPTION OF THE DRAWINGS

FIG. 1 shows a typical situation for impaired automatic speech recognition in a motor vehicle.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

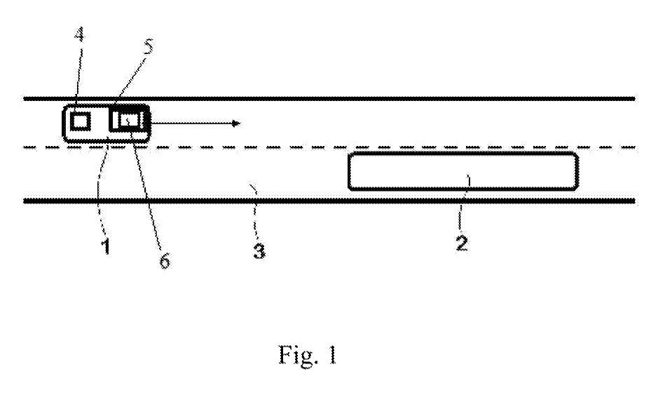

FIG. 1 depicts a schematic view of a vehicle 1 travelling on a road 3 toward an object 2. The motor vehicle 1 contains a voice control system 4 and an environment sensor system 5 comprising at least one imaging sensor system 6, such as, for example, one or more cameras that may operate in the visible or invisible range, lidar systems (e.g. laser scanners), radar sensors and/or ultrasound sensors, which observe at least an environment in front of the vehicle 1, but any environment sensor also observing to a side and/or to a rear is preferably used for this purpose.

Using the sensor signals or environment information acquired therefrom, a provisional identification and classification are performed in respect of situations on a public road 3 on which the vehicle 1 is currently located, i.e. situations that are typically accompanied by time-variant noises that have an influence on a voice control system 4.

For each situation identified in this way, it is determined when a possible influence on a quality of speech recognition of the voice control system 4 is expected to start and end, and the most probable amplitude and/or distribution for the determined situation class of the noise to be expected on the basis of the identified situation is determined.

The two parameters for a start and end of tan expected influence on speech recognition quality can be very readily determined using a combination of environment sensors from the imaging sensor system 6, which comprise the aforementioned sensors or further sensors that are suitable to supply information relating to a relative movement and size of objects in an immediate vicinity of the vehicle 1.

A particularly reliable object identification and classification can be achieved through fusion of all sensor data available in the vehicle and suitable for observation. Such a sensor fusion, known per se, also makes it easier to draw the correct conclusions and estimate an influence that an object will have on speech recognition quality.

This means that, in order to minimize speech recognition errors, environment information is first acquired and, in a second step, an identification and classification of objects 2 are performed. The identification consists of a recognition of relevant objects 2 that may interfere with speech recognition, and the classification determines a class of objects 2 that most closely matches the sensor data from a number of predefined classes for most probable classes of objects 2, i.e. those most frequently encountered in road traffic, e.g. passenger vehicles, trucks, motorcycles, trams, etc.

Descriptive parameters, including expected noise pattern, expected strength of the influence on speech recognition, object size, object speed or object speed relative to the vehicle 1, object structure, etc., are assigned in each case to these classes or to the objects 2 included therein.

If an object 2 is recognized as a member of one of the predefined classes, the object 2 can be described by a specific set of parameters of this type, which can be specified in part in advance on the basis of available statistical data and can be determined in part by recording and evaluating noise patterns of objects 2 of all possible classes, for example in advance in test drives, and/or can be acquired in ongoing driving operation and/or can be improved e.g. through self-learning.

This enables the influence of known objects 2 and possibly new objects 2, i.e. objects 2 newly classified in normal driving operation, to be predicted using the class of a recognized object 2 that is most probable according to the sensor data and stored noise patterns of nearest neighbors in this class. The nearest neighbors are determined on the basis of the object size, object structure, object speed, etc., i.e. a geometry or dynamic or structural parameters of an object 2. All these parameters are determined using the ambient sensor system 6 of the vehicle 1.

The noise parameters are predicted from object parameters on the basis of class parameters and parameters of members of the class closest to the identified object 2, wherein the latter parameters are determined by recording an influence of corresponding object noise.

In a first step, for parameter definition, geometric and dynamic object parameters, such as e.g. object size, object structure, object speed, etc., are determined from the available vehicle sensors 6 to monitor the environment.

In a second step, the parameters of the noise influence are determined in recorded data. These data should be recorded with all available sensors 6, such as microphones in order to optimize noise extraction capabilities of the voice control system 4 and speech analysis.

Furthermore, noise suppression methods, such as, for example, ESPRIT (Estimation of Signal Parameters via Rotational Invariance Techniques) or MUSIC (MUltiple SIgnal Classification) or other “signal subspace” noise suppression methods are more efficient if the recording space (the number of microphones) increases.

Recognized objects 2 and identifiers for their classes can be stored in a database, which may consist of classes of objects 2 and, where appropriate, object-passing events, in particular mean values of many such objects 2 or events. A currently recognized object 2 close to the vehicle 1 can then be compared with objects 2 in the database in order to adjust the voice control system 4 according to passing of the currently recognized object 2.

FIG. 1 shows a typical situation in which the speech recognition in a passenger vehicle 1 is impaired, i.e. when the passenger vehicle 1 moving in a direction indicated by an arrow passes the object 2, or, in this case, a truck 2 either by overtaking the truck 2, by driving toward the truck 2 or, in the case of a stationary truck 2, by passing in close proximity to the truck 2 on the public road 3.

The passenger vehicle 1 contains a plurality of microphones (not shown) distributed in a passenger compartment (not shown), and also a voice control system 4 that enables voice control of vehicle functions by a driver (not shown) of the passenger vehicle 1 via speech recognition. In this way, the voice control system uses a processor that enables voice control of vehicle functions.

The passenger vehicle 1 also contains an environment sensor system 5, which enables an anticipatory acquisition of parameters of the truck 2, in particular truck speed or speed relative to the passenger vehicle 1, an intrinsic speed of which is known, a duration of an expected noise impairment, dimensions and type of the truck 2, distance during the passing, etc.

The truck 2 is scanned by the sensor system 5 and classified e.g. as a semitrailer truck 2. Many noise patterns that typically occur when passing various vehicles and vehicle types are stored in the voice control system 4 and, from noise patterns stored for semitrailer trucks 2, a pattern is selected that most closely matches acquired parameters of the truck 2.

Using the selected noise pattern, the voice control system 4 in the passenger vehicle 1 is improved in a manner known per se as it passes the truck 2, or suitable countermeasures are taken.

In particular, measures that prevent or at least render less probable speech recognition errors, in particular misinterpretations of content of voice commands issued at a same time or misinterpretations of driving noises as any voice command can be taken for a duration of predicted driving noises originating from passing the truck 2.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to improve temporarily impaired automatic speech recognition of a telecommunication system in a vehicle comprising:
observing at least an environment in a direction of travel of a vehicle with one or more sensors of the vehicle to create observation data;
using the observation data, identifying objects in the environment indicative of potential time-variant noise sources that are expected, based on a detected relative vehicle movement between the vehicle and the objects, for the vehicle to be approaching close enough to the objects to impair the speech recognition;
using the noise sources, identifying a start and end of an expected influence of the objects on the speech recognition; and
applying countermeasures for the expected influence due to the vehicle passing the objects.

2. The method as claimed in claim 1 further comprising classifying each of the objects as falling within one of a plurality of classes based on parameters indicative of object speed, object speed relative to vehicle speed, and object dimensions.

3. The method as claimed in claim 2 further comprising storing at least one characteristic noise pattern for each class of objects, wherein the countermeasures use one of the noise patterns that approximates a currently detected object according to the parameters.

4. The method as claimed in claim 3 further comprising using at least one microphone during driving to continuously record a sound signal from passing objects such that noise patterns and characteristic noise parameters are used as empirical values to approximate the currently detected object.

5. The method as claimed in claim 1, wherein the sensors include one or more cameras, lidar sensors, radar sensors, and/or ultrasound sensors, to acquire two-dimensional or three-dimensional images.

6. The method as claimed in claim 1, wherein the objects are vehicles on a public road.

7. The method as claimed in claim 4, wherein the countermeasures include switching operating modes for a duration of the expected influence based on the empirical values to reduce an error rate of word recognition of the speech recognition.

8. The method as claimed in claim 7 further comprising, in response to switching operating modes, temporarily applying the countermeasures including a noise suppression method to reduce the expected influence on speech signals for the duration of the expected influence.

9. A vehicle, comprising:
a sensor system to observe an environment in a travel direction of the vehicle and generate observation data of the environment that identifies objects in the environment indicative of expected time-variant noise sources; and
a voice control system configured to, in response to the observation data and a detected, relative vehicle movement approaching the objects, identify start and end times defining a duration of an expected influence of the objects on speech recognition and switch operating modes for the duration based on empirical values derived from noise patterns and characteristic noise parameters that approximates the expected influence to reduce an error rate of word recognition.

10. The vehicle as claimed in claim 9, wherein the objects are vehicles on a public road.

11. The vehicle as claimed in claim 9, wherein the voice control system is configured to classify the objects as being within one of a plurality of classes based on parameters indicative of object speed, object speed relative to vehicle speed, and object dimensions.

12. The vehicle as claimed in claim 9, wherein the voice control system is configured to store the noise patterns and characteristic noise parameters of the objects for each class of the plurality of classes to approximate the expected influence.

13. The vehicle as claimed in claim 12 further comprising a microphone to continuously record a sound signal from passing objects to store noise patterns and characteristic noise parameters that approximate the objects.

14. The vehicle as claimed in claim 9, wherein the voice control system is configured to, in response to the switch of operating modes, temporarily apply noise suppression to reduce the expected influence on speech signals for the duration.

15. A vehicle control system comprising:
a processor that, responsive to objects identified in environment observation data detected from sensors, and a relative vehicle movement approaching the objects, identifies an expected influence duration of the objects based on empirical values derived from noise patterns and characteristic noise parameters that approximate an expected influence of time-variant noise sources, and switches operating modes for the duration to reduce an error rate of word recognition.

16. The vehicle control system as claimed in claim 15, wherein the objects are vehicles on a public road.

17. The vehicle control system as claimed in claim 15, wherein the processor is configured to, in response to the switch of operating modes, temporarily apply noise suppression to reduce the expected influence on speech signals for the duration.

18. The vehicle control system as claimed in claim 15, wherein the processor is configured to classify the objects as being within one of a plurality of classes based on parameters indicative of object speed, object speed relative to vehicle speed, and object dimensions.

19. The vehicle control system as claimed in claim 18, wherein the processor is configured to store the noise patterns and characteristic noise parameters of the objects for each class of the plurality of classes to approximate the expected influence.

20. The vehicle control system as claimed in claim 19 further comprising a microphone to continuously record a sound signal from passing objects to store the noise patterns and characteristic noise parameters to approximate the objects.
